(19) United States
(12) Patent Application Publication
(10) Pub. No.: US 2012/0188271 A1
(43) Pub. Date: Jul. 26, 2012

(54) METHOD AND APPARATUS FOR CAPTURING SCREEN IN PORTABLE TERMINAL

(75) Inventor: Do-Hoon Kim, Goyang-si (KR)

(73) Assignee: SAMSUNG ELECTRONICS CO., LTD., Suwon-si (KR)

(21) Appl. No.: 13/355,389

(22) Filed: Jan. 20, 2012

(30) Foreign Application Priority Data
Jan. 21, 2011 (KR) 10-2011-0006156

(51) Int. Cl. G09G 5/00

(52) U.S. Cl. 345/620

(57) ABSTRACT

A portable terminal includes an apparatus for capturing a screen. The apparatus determines a capture scope; and captures contents displaying within a determined capture scope to an image.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 21, 2011 and assigned Serial No. 10-2011-0006156, the entire disclosure of which is hereby incorporated by reference.

### TECHNICAL FIELD OF THE INVENTION

The present invention relates to a method and apparatus for capturing a screen in a portable terminal. More particularly, the present invention relates to a method and apparatus for capturing a screen capable of determining a scope intended to capture in a screen.

### BACKGROUND OF THE INVENTION

The portable terminal, such as a mobile communication terminal, an electronic scheduler, a personal complex terminal, and so forth, owing to the advance of the present electronic communication industry uses to necessaries of modern society, is becoming an important means to transfer the information that is swiftly changed.

As everyone knows, the portable terminal provides various services via the Internet. These services are e-mail, connection to a remote computer, file transfer, Internet information search, Internet conversation and discussion, electronic bulletin board, and reading hypertext information, and so forth. Also, as the recent portable terminal includes a touch screen and, in fact, the touch screen has helped so that a user conveniently uses the above service.

As a user reads this service, a user occasionally needs to photo a shown screen, picture, and knowledge, and so forth. At this time, a generally used method is a screen capture. The screen capture generates contents displaying on a full screen to an image. The general screen capture is a problem in which an undesirable part is captured because of applying to the full screen.

### SUMMARY OF THE INVENTION

To address the above-discussed deficiencies of the prior art, it is a primary object to provide a method and apparatus for capturing a screen capable of determining a scope intended to capture in a screen.

Another aspect of the present invention is to provide a method and apparatus for determining a scope intended to capture by using the multi touch and capturing the contents displaying within the determined scope to an image

Still another aspect of the present invention is to provide a method and apparatus for obtaining a still image from video data played back and including the obtained still image to a capture object.

In accordance with an aspect of the present invention, a method for capturing a screen in a portable terminal comprises the steps of determining a capture scope; and capturing contents displaying within a determined capture scope to an image.

In accordance with another aspect of the present invention, a portable terminal that stores telephone number comprises a touch screen unit that inputs and outputs; a memory that stores data; and a controller that controls the overall operation, wherein the controller determines a capture scope, and captures contents displayed within determined capture scope to an image.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a block diagram of a touch screen terminal according to an embodiment of the present invention;

FIG. 2 illustrates a flowchart for a screen capture procedure according to an embodiment of the present invention;

FIGS. 3A and 3B illustrate a screen displayed a method which a user determines a capture scope in a touch screen in accordance with an embodiment of the present invention;

FIG. 4 illustrate a screen displayed a method which a user determines a screen capture scope in a touch screen in accordance with an embodiment of the present invention; and

FIGS. 5A and 5B illustrate a screen displayed a method which a user captures a screen in a touch screen in accordance with an embodiment of the present invention.

### DETAILED DESCRIPTION OF THE INVENTION

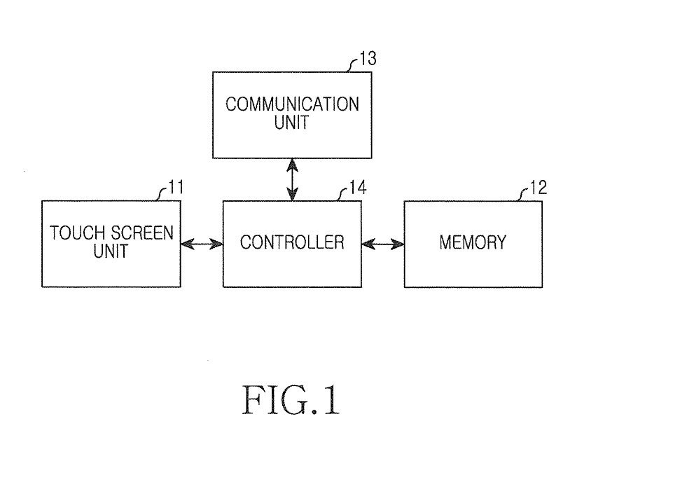

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Hereinafter, the exemplary embodiments of the present invention will be described in detail with reference to the accompanying drawings. However, in the following description, well-known functions or constructions are not omitted detailed description in case that a detailed description is judged to obscure a major point of the invention.

The present invention relates to a method and apparatus for capturing a screen in a portable terminal. More particularly, the present invention relates to a method and apparatus for capturing a screen capable of determining a scope intended to capture in a screen.

FIG. 1 illustrates a block diagram of a touch screen terminal according to an embodiment of the present invention.

Referring to FIG. 1, a touch screen terminal according to the present invention comprises a touch screen unit 11 for inputting and outputting; a memory 12 for storing data; a communication unit 13 for communicating; and a controller 14 for carrying out the control of the overall operation;

The touch screen unit 11 outputs an input signal generated by touching to the controller 14 and displays by receiving data to display corresponding to the input signal in accordance with the control of the controller 14.

The memory 12 stores a program for controlling the overall operation of the touch screen terminal and all sorts of data inputted and outputted upon carrying out the control operation of the touch screen terminal. The memory 12 stores a captured image in accordance with an embodiment of the present invention.

The controller 14 controls the overall operation of the touch screen terminal. Hereinafter, the embodiment of the present invention of the controller 14 will be described in detail with reference to the accompanying drawings.

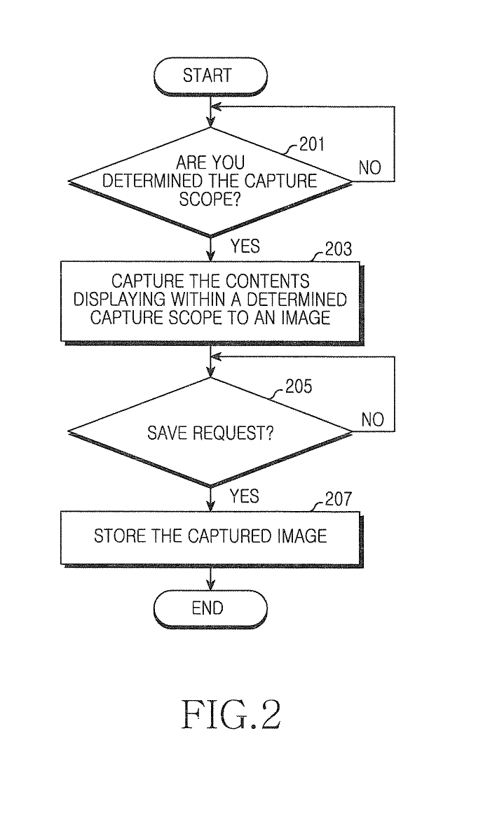

FIG. 2 illustrates a flowchart for a screen capture procedure according to an embodiment of the present invention. Prior to explaining FIG. 2, a capture mode according to an embodiment of the present invention is regarded as carrying out. For example, if a user pushes a hot key while reading a web page, a capture mode according to an embodiment of the present invention carries out.

Referring to FIG. 2, the controller 14 confirms whether a scope intended to capture in a screen (Hereinafter, a scope is regarded as a capture scope) determines (block 201).

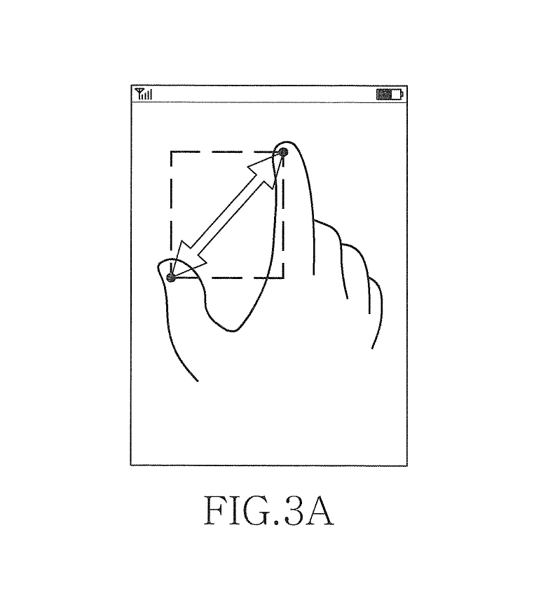

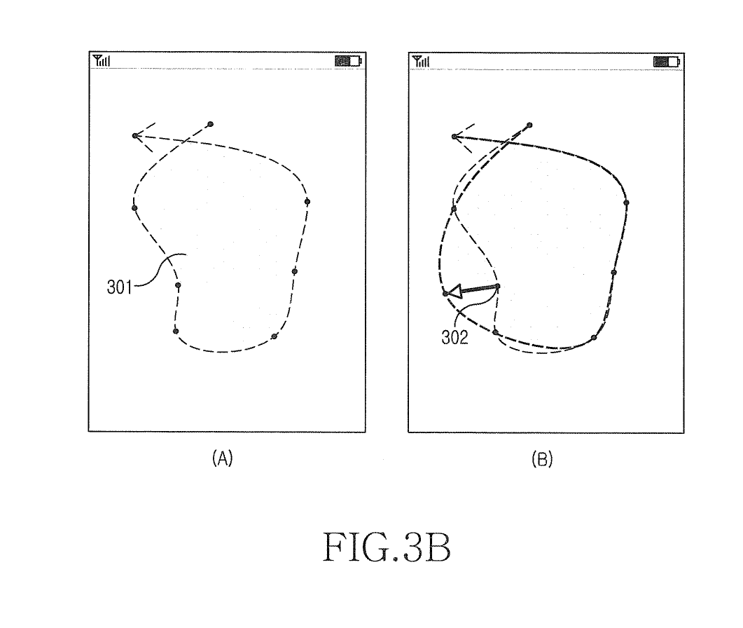

FIGS. 3A and 3B illustrate a screen displayed a method which a user determines a capture scope in a touch screen in accordance with an embodiment of the present invention.

Referring to FIG. 3A, the capture scope can be designated by the multi touch. The multi touch sets up a square capture scope which two touched points are diagonally formed. If the two touched points move, a capture scope will be changed. For example, if a user widens the distance between two points by spreading two fingers, a capture scope is increased. However, if a user decreases the distance between two points by closing the gap of two fingers, the capture scope is decreased. When a user removes the touch later, the capture scope is determined.

Referring to FIG. 3B, a closing area 301 made a path of touch movement can be determined to a capture scope (a). Moreover, it can be revised a capture scope determined in FIG. 3B (a). As shown in FIG. 3B, upon an update request, it is provided new axis points 302 capable of modifying an existing touch path. A user can modify a closed area which is a capture scope by moving a corresponding new axis points. In block 201 in FIG. 2, a capture scope determining process includes a process for modifying the capture scope.

The controller 14 captures contents displayed in the determined capture scope to an image (Block 203), and the user starts to the capture corresponding to the determined capture scope by pushing a corresponding button. As shown an example in FIG. 3A, upon removing the touch, the capture scope is determined. Simultaneously, a capture corresponding to the determined capture scope can be started.

If a screen played back video data includes in the gross or partially within the determined capture scope, the controller 14 obtains a still image of video data at the point of time which is called for starting the capture, and includes the still image to the capture object. Then, the controller 14 selects an area belong to the capture scope in the still image.

Upon the save request 205, the controller 14 lets a captured image store in the memory 12 (block 207).

Especially, a process of expanding, reducing or scrolling a screen may be processed before and after a capture mode according to an embodiment of the present invention executes.

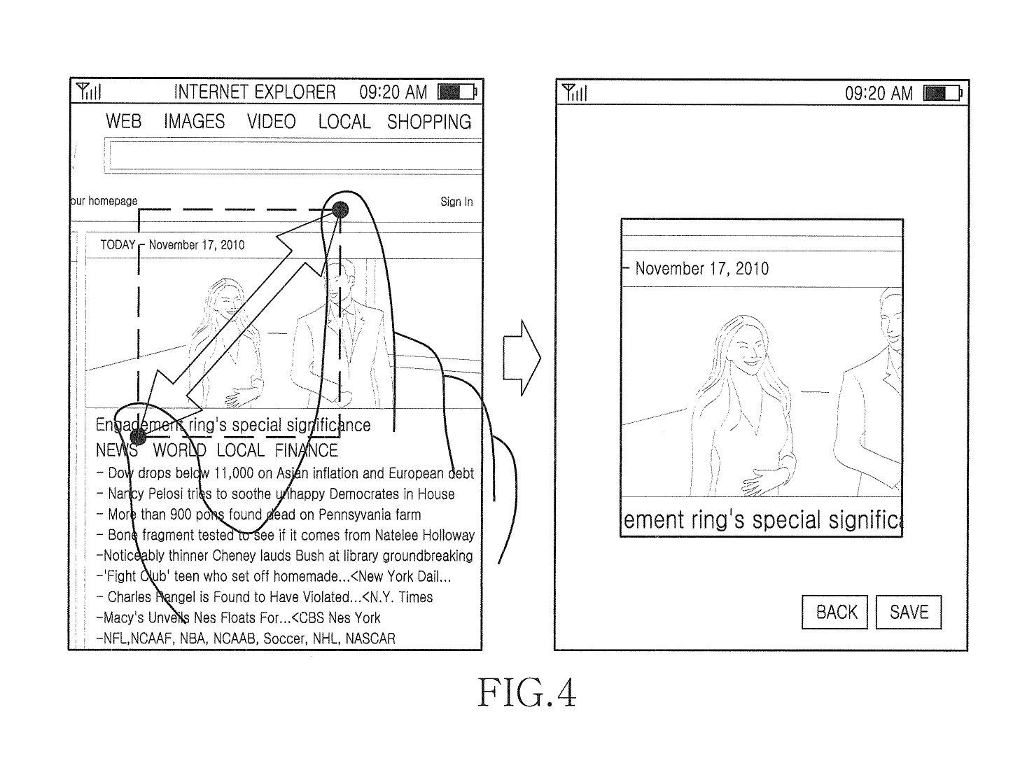

FIG. 4 illustrates a screen displayed a method which a user determines a screen capture scope in a touch screen in accordance with an embodiment of the present invention.

Referring to FIG. 4, a user is able to determine a square capture scope from a process connected to the multi touch from moving to removing a touch point. After multi touch, to be changed a capture scope in accordance with the movement of touch point displays. When the square capture scope is determined, the controller 14 captures contents displayed the determined capture scope to an image. Then, the controller 14 switches over a screen or displays an image captured onto an additional screen. A user can confirm whether the right capture executes or not. After this time, upon a save request, the controller 14 lets the captured image store in a corresponding memory.

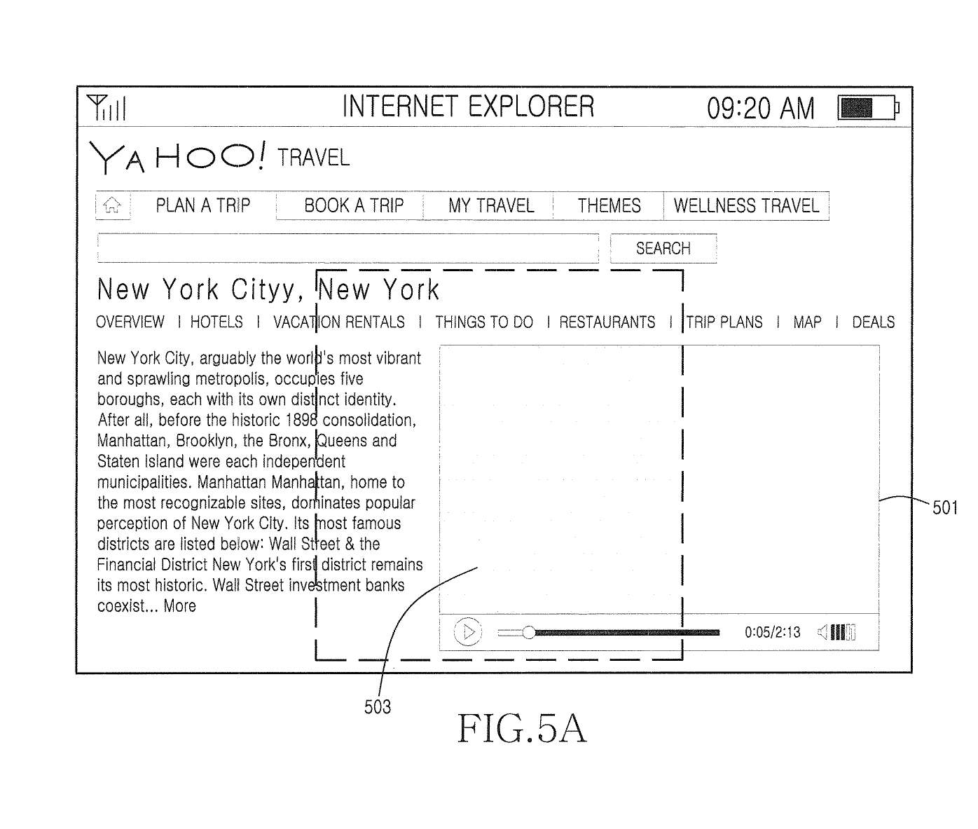

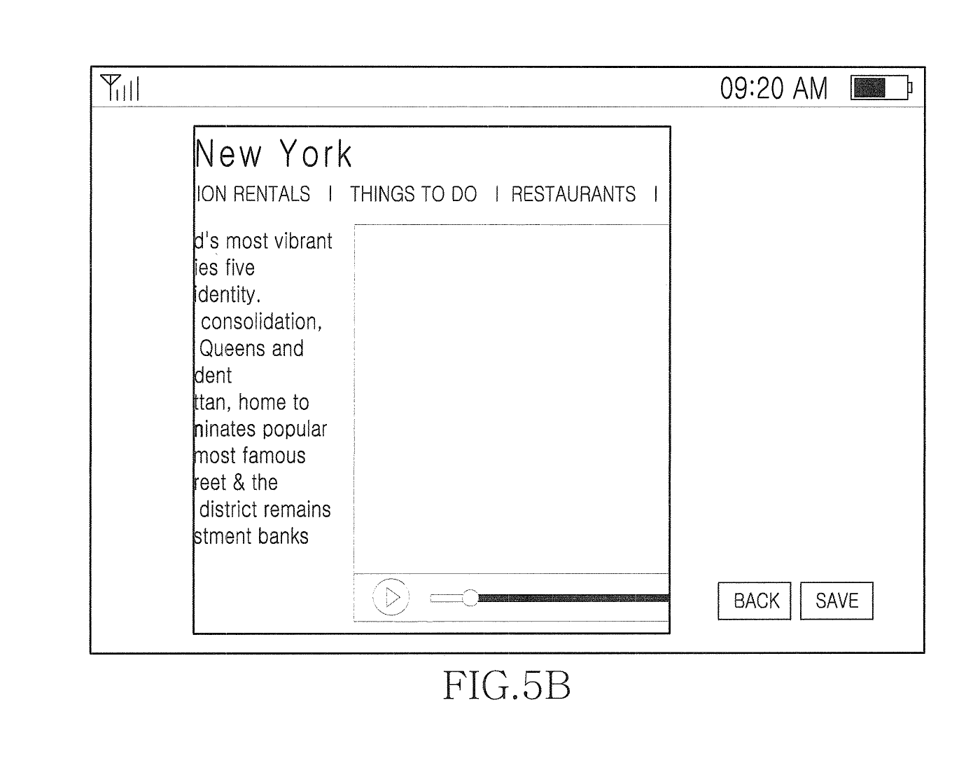

FIGS. 5A and 5B illustrate a screen displayed a method in which a user captures a screen in a touch screen in accordance with an embodiment of the present invention. A user reads a web page including a screen 501 for playing back video data.

Referring to FIGS. 5A and 5B, when a user determines a square capture scope by multi touch, it captures contents displayed in the determined capture scope to an image. To remarkably attract an attention, when video data played back the determined capture scope exists, the controller 14 obtains a still image from video data at a time called for starting to capture, and includes a still image to a capture object. Thereafter, the controller 14 selects an area 503 belong to a capture scope in the still image. Then, the controller 14 switches over a screen or displays a captured image onto an additional screen. A user is able to confirm whether a right capture executes or not. After this time, upon a save request, the controller 14 stores the captured image in a corresponding memory.

As described above, a screen capture method according to an embodiment of the present invention described with reference to a touch screen terminal. However, not to be limited, a screen capture method according to an embodiment of the present invention can be applied even in a terminal which does not apply to a touch screen. That is, a series of procedures from a process for determining a capture scope by using a general key which is not the touch to a capture complete process will be executed.

Consequently, the method and apparatus for capturing a screen according to the present invention does not capture to the end of an unnecessary part because of determining a scope intended to capture in a screen.

Alternatively, while the present invention has been particularly shown and described with reference to exemplary embodiments thereof, it will be understood by those skilled in the art that various changes in form and details may be made therein without departing from the spirit and the scope of the present invention as defined by the appended claims.

What is claimed is:

1. A method for capturing a screen in a portable terminal, the method comprising:
determining a capture scope; and
capturing contents displaying within a determined capture scope to an image.

2. The method of claim 1, wherein determining a capture scope comprises:
detecting two touch points;
displaying a square area which is diagonally formed two touch points;
detecting to be moved two touch points, and displaying by updating a square area corresponding to two touch points moving; and
determining a square area corresponding to two final touch points to a capture scope, and displaying a captured image when removing the touch.

3. The method of claim 2, wherein determining a capture scope:
detecting a touch movement;
confirming whether a closed area in a path of the touch movement is or not; and
determining the closed area confirmed to a capture scope, and displaying a captured image when removing the touch.

4. The method of claim 3, further comprising:
displaying a plurality of new axis points moveable on a touch path upon an update request of determined capture scope;
changing and displaying the touch path corresponding to the new axis points when the movement of a corresponding new axis point detects; and
determining a closed area existed in a changed touch path to a new capture scope, and displaying a captured image upon a stop request.

5. The method of claim 1, further comprising:
storing a captured image upon a save request

6. The method of claim 1, wherein capturing contents displaying within the determined capture scope to an image comprises:
obtaining a still image from video data playing back while playing back video data within a determined capture scope; and
including a part included within a capture scope in an obtained still image to the capture scope.

7. The method of claim 1, wherein capturing contents displaying within the determined capture scope to an image directly at least one of executes when determining the capture scope, or executes upon a separate start request.

8. An apparatus for capturing a screen in a portable terminal, the apparatus comprising:
a touch screen unit configured to receive an input and to provide an output;
a memory configured to store data; and
a controller configured to control the overall operation,
wherein the controller is configured to determine a capture scope and capture contents displayed within determined capture scope to an image.

9. The apparatus of claim 8, wherein the controller is configured to display a square area that is formed diagonally between two touch points detected, update and display a square area corresponding to two touch points when detecting the movement of detected two touch points, determine a square area corresponding to two final touch points when removing the touch, and display a captured image.

10. The apparatus of claim 8, wherein the controller is configured to confirm whether a closed area in a path of detected touch movement is or not, and determine a closed area confirmed to a capture scope and display a capture image when removing the touch.

11. The apparatus of claim 10, wherein the controller is configured to
display a plurality of new axis points moveable on a touch path upon an update request of determined capture scope;
change and display the touch path corresponding to the new axis points when the movement of a corresponding new axis point detects; and
determine a closed area existed in a changed touch path to a new capture scope, and displays a captured image upon a stop request.

12. The apparatus of claim 8, wherein the controller is configured to store a captured image in a memory upon a save request.

13. The apparatus of claim 8, wherein the controller is configured to obtain a still image from video data playing back while playing back video data within the determined capture scope; and include a part included within a capture scope in an obtained still image to the capture scope.

14. The apparatus of claim 8, wherein the controller is configured to execute so as to capture contents displayed within the determined capture scope to an image upon determining the capture scope or a separate start request.

15. A portable terminal comprising a screen capture apparatus configured to capture an image on a display of the portable terminal, the apparatus comprising:
a touch screen unit configured to receive an input and to provide an output;
a memory configured to store data; and
a controller configured to control the overall operation,
wherein the controller is configured to determine a capture scope and capture contents displayed within determined capture scope to an image.

16. The portable terminal of claim 15, wherein the controller is configured to display a square area that is formed diagonally between two touch points detected, update and display a square area corresponding to two touch points when detecting the movement of detected two touch points, determine a square area corresponding to two final touch points when removing the touch, and display a captured image.

17. The portable terminal of claim 15, wherein the controller is configured to confirm whether a closed area in a path of detected touch movement is or not, and determine a closed area confirmed to a capture scope and display a capture image when removing the touch.

18. The portable terminal of claim 17, wherein the controller is configured to:
display a plurality of new axis points moveable on a touch path upon an update request of determined capture scope;
change and display the touch path corresponding to the new axis points when the movement of a corresponding new axis point detects; and
determine a closed area existed in a changed touch path to a new capture scope, and displays a captured image upon a stop request.

19. The portable terminal of claim 15, wherein the controller is configured to store a captured image in a memory upon a save request.

20. The portable terminal of claim 15, wherein the controller is configured to obtain a still image from video data playing back while playing back video data within the determined capture scope; and include a part included within a capture scope in an obtained still image to the capture scope.
